(19) United States
(12) Patent Application Publication
(10) Pub. No.: US 2002/0046855 A1
(43) Pub. Date: Apr. 25, 2002

(54) UNDERFILL REMOVAL FOR EASING SEPARATION OF AN INTEGRATED CIRCUIT DEVICE AND PACKAGE

(76) Inventors: COLIN HATCHARD, CAMPBELL, CA (US); DANIEL YIM, FREMONT, CA (US)

Correspondence Address: JOSEPH A SAWYER JR, SAWYER & ASSOCIATES, P O BOX 51418, PALO ALTO, CA, 94303

(21) Appl. No.: 09/273,231

(22) Filed: Mar. 18, 1999

(51) Int. Cl. H02G 3/08

(52) U.S. Cl. 174/52.1

(57) ABSTRACT

Aspects for easing separation of an integrated circuit device during removal of the integrated circuit device from a device package are described. In an exemplary method aspect, the method includes removing underfill material between the integrated circuit device and the device package with an ultrasonic acid wash. The method further includes performing device extraction to remove the integrated circuit device from the device package.

### FIELD OF THE INVENTION

The present invention relates to multi-layer integrated circuit (IC) devices, and more particularly to extraction of multi-layer IC devices oriented with limited frontside access.

### BACKGROUND OF THE INVENTION

For multi-layer IC devices oriented with limited frontside access, debugging for defects in the IC is difficult due to having to approach the desired layers from the backside of the device. FIG. 1 illustrates a sideview block diagram of an IC in a typical flip-chip configuration. As shown in FIG. 1, an IC device 10 is coupled to a ceramic package 12 (e.g., a C4 package) via solder bumps 14. The solder bumps 14 act as chip-to-carrier interconnects to attach the IC device 10 to the ceramic package 12 and to mate with corresponding pad patterns to form the necessary electrical contacts between the circuit(s) of the IC device 10 and pins of the package 12.

Testing of the circuit remains a challenge due to the upside-down nature of the device orientation. While the circuit may be approached through the backside layers, such techniques are usually not preferred due to the difficulties associated with having to access the layers in an unconventional order. Further, these techniques normally reduce the thickness of the device to reach the circuit, making the device extremely fragile and cumbersome to handle and utilize during testing. To test the circuit more conventionally from the frontside requires separation of the device from its package, which creates additional difficulties and more chances for device damage and breakage.

Accordingly, a need exists for an efficient procedure for separation of a device and its package for an IC device mounted in a flip-chip orientation. The present invention addresses such a need.

### SUMMARY OF THE INVENTION

The present invention provides aspects for easing separation of an integrated circuit device during removal of the integrated circuit device from a device package. In an exemplary method aspect, the method includes removing underfill material between the integrated circuit device and the device package with an ultrasonic acid wash. The method further includes performing device extraction to remove the integrated circuit device from the device package.

Through the present invention, more efficient underfill removal is achieved for IC devices. The present invention utilizes an ultrasonic passive acid wash and effectively avoids potential damage associated with high temperature underfill removal methods. These and other advantages of the aspects of the present invention will be more fully understood in conjunction with the following detailed description and accompanying drawings.

### BRIEF DESCRIPTION OF THE DRAWINGS

FIG. 1 illustrates a sideview diagram of a typical flip-chip multi-layer integrated circuit.

FIG. 2 illustrates a flow diagram of a procedure for removal of a multi-layer integrated circuit device mounted in a flip-chip orientation from its package in accordance with the present invention.

FIGS. 3 and 4 illustrate a partial cross-section of the multi-layer integrated circuit device and package during the procedure illustrated in FIG. 2.

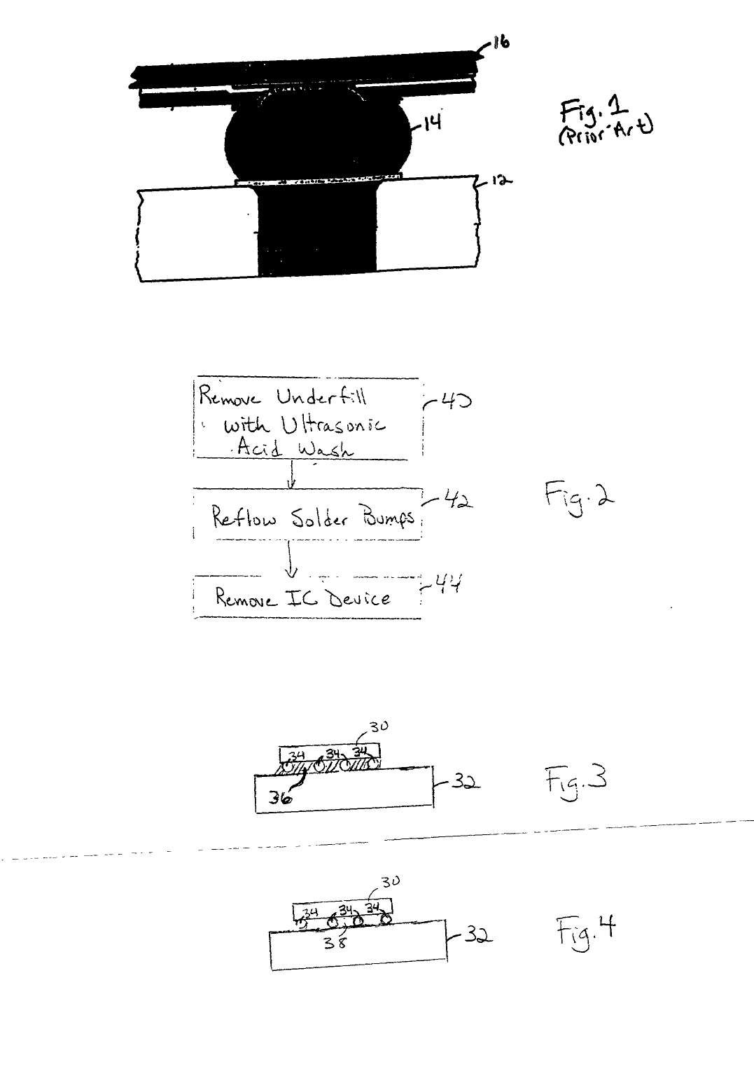

### DETAILED DESCRIPTION

The present invention relates to a procedure for removal of multi-layer integrated circuit devices coupled at a frontside from device packaging. The following description is presented to enable one of ordinary skill in the art to make and use the invention and is provided in the context of a patent application and its requirements. Various modifications to the preferred embodiment and the generic principles and features described herein will be readily apparent to those skilled in the art.

FIG. 2 illustrates a block flow diagram of a process for device removal of integrated circuit devices from device packaging in accordance with the present invention. FIG. 3 illustrates an example of an IC device 30 oriented for frontside coupling, such as in a flip-chip orientation, and mounted to a pin grid array (PGA) package 32 via solder bumps 34. Surrounding the solder bumps 34 is underfill material 36, e.g., a polymer material that adds rigidity to the structure. The process of removing the device 30 from the package 32 begins with removal of the underfill material 36 (step 40, FIG. 2). In accordance with the present invention, an ultrasonic passive acid wash is utilized for the removal of the underfill material.

FIG. 4 illustrates the device of FIG. 3 following removal of the underfill material 36. As shown by FIG. 4, with the use of the ultrasonic acid wash in accordance with the present invention, the underfill material is substantially removed from throughout the solder bumps 34, including in a center section 38 of the structure. Thus, problems associated with prior art acid washes, including inefficiency due to wicking of the acid from the outside, i.e., drawing off of the liquid by capillary action away from the center, which results in insufficient removal of the underfill material, are avoided. Further, the ultrasonic acid wash eliminates the need to apply high temperatures for long periods of time to the device, as is typically done to counteract the underfill material and that often damages the device.

Once the underfill material is removed via the ultrasonic acid wash, the processing to separate the device 30 from the package 32 continues with reflowing of the solder bumps 34 (step 42, FIG. 2). Preferably, the reflowing occurs as a result of heating the solder to a temperature at or above which the solder melts, as is well understood by those in the art. With the solder bumps melted, the security of contact is sufficiently loosened to allow removal of the device 30 from the package 32 by well known techniques. Further utilization of the device 32 may then be performed, such as to perform device testing from a frontside.

Although the present invention has been described in accordance with the embodiments shown, one of ordinary skill in the art will recognize that there could be variations to the embodiment and those variations would be within the spirit and scope of the present invention. Accordingly, many modifications may be made by one of ordinary skill without departing from the spirit and scope of the present invention, the scope of which is defined by the following claims.

What is claimed is:

1. A method for easing separation of an integrated circuit device during removal of the integrated circuit device from a device package, the method comprising:
removing underfill material between the integrated circuit device and the device package with an ultrasonic acid wash; and
performing device extraction to remove the integrated circuit device from the device package.

2. The method of claim 1 wherein performing device extraction further comprises reflowing solder bumps coupling the integrated circuit device to the device package.

3. The method of claim 2 wherein reflowing solder bumps further comprises heating the solder bumps to a temperature of at least a melting point temperature for the solder bumps.

4. The method of claim 2 wherein performing device extraction further comprises removing the integrated circuit device from the reflowed solder bumps.

5. The method of claim 1 wherein the device package further comprises a pin grid array package.

6. The method of claim 1 further comprising performing device testing with the extracted integrated circuit device.

7. The method of claim 1 wherein removing underfill further comprises substantially penetrating a center portion of underfill material between the integrated circuit device and the device package with the ultrasonic acid wash.

8. An integrated circuit device arrangement comprising:
a device package;
an integrated circuit device coupled at a frontside to the device package through solder bumps; and
underfill material, the underfill material substantially surrounding the solder bumps and adding rigidity, the underfill material removed with an ultrasonic acid wash solution penetrating between the device package and the integrated circuit device for assisting in separation of the integrated circuit device from the device package.

9. The arrangement of claim 8 wherein the device package farther comprises a pin grid array.

10. The arrangement of claim 8 wherein the ultrasonic acid wash solution substantially penetrates a center portion of the underfill material between the device package and the integrated circuit device.

11. The arrangement of claim 8 wherein the underfill material comprises a polymer.

12. The arrangement of claim 8 wherein the integrated circuit device is oriented in a flip-chip orientation.
